(19) United States
(12) Patent Application Publication
(10) Pub. No.: US 2011/0265423 A1
(43) Pub. Date: Nov. 3, 2011

(54) Device And Method For Installing Building Material

(76) Inventor: Frank M. Richmond, Harvard, IL (US)

(21) Appl. No.: 13/179,263

(22) Filed: Jul. 8, 2011

Related U.S. Application Data
(63) Continuation of application No. 11/098,638, filed on Apr. 4, 2005.
Application No. 11/098,638 is a continuation-in-part of application No. 09/722,949, filed on Nov. 27, 2000, now Pat. No. 6,904,732.

(51) Int. Cl. B25B 5/00; E04B 1/38

(52) U.S. Cl. 52/749.1

(57) ABSTRACT

The present invention provide an apparatus, devices and/or systems for the installation of building material which allows one individual on his own to install building material. The device includes at least one resting surface spaced apart from a fastener.

The present application is a continuation of U.S. application Ser. No. 11/098,638, filed Apr. 4, 2005, which is a continuation-in-part of U.S. application Ser. No. 09/722,949, filed Nov. 27, 2000, both of which are incorporated herein by reference.

The present invention relates to installation of building materials, and more particularly, to devices that temporarily secure building materials, either overhead or on walls, until the installer can permanently secure the material into position.

### BACKGROUND

The burdensome task of installing building materials, such as drywall, is usually cumbersome and labor intensive. The process of installing these large, cumbersome and heavy drywall sheets for covering walls and ceilings usually has been assigned to two or more people. In order to correctly install drywall as ceiling sheets or wall sheets, the drywall sheets must first be lifted and placed into the desired position. With the drywall sheet being supported by at least one person, a second person must then secure the drywall sheet to the overhead joists or wall joists via a means of attachment, one of the more common ways being with screws. Usually screw guns are employed to speed up the process. While a minimum of two people are usually desired for this particular job, sometimes one person is left to accomplish this task all by thereself. This usually involves the installer balancing the panel on his head and/or using a tee bar (a tee bar is usually constructed from two pieces of 2″×4″ wood with the vertical leg being 2″ to 3″ longer than the height of the ceiling) to free his hands in order to apply the means of attachment to attach the sheet of drywall to the structure. This practice is dangerous, leaves little room for adjustments and potentially adds to the amount of scrapped material. Therefore, there is a need for an invention which can temporarily hold a drywall sheet or other building materials in place while the installer is able to do final adjustments to the location and permanently secure the panel to the supporting joists.

One method that is often used to install drywall involves the use of a drywall lift. Sheets of drywall are placed on the drywall lift and then raised into position. One major disadvantage of using a drywall lift is that the drywall lift itself is cumbersome to assemble and disassemble. Movement of the drywall lift from one floor to another is therefore difficult due to the usual need to assemble and disassemble the drywall lift. Further, drywall lift's are often difficult to locate in small or irregular shapes spaces.

One example of a device for aiding in the installation of drywall sheets and other building materials is described in U.S. Pat. No. 5,366,329. This patent describes a rotatable device having an integral “Z” shaped body is used to temporarily hold the drywall panel to the ceiling. This device is only capable of being rotated and does not have the option to be locked in a secure position. This causes a problem if the drywall sheet needs to be adjusted to properly fit into the desired position. Likewise, a problem exists when abutting one piece of dry wall next to another. Hence, an installer using the device still requires a minimum of one hand to hold the dry wall in place while the other secures it to the ceiling joists. Further, the device requires multiple components to manufacture it in its simplest form and requires the use of a relatively expensive shoulder screw. With frequent use of the shoulder, the screw head strips, requiring disassembly of the device to replace the screw.

Another device used to facilitate the installation of building materials is described in U.S. Pat. No. 5,002,446. This patent describes an overhead support device with an angled surface and widened edges. A tapered screw is embodied inside the housing which is used to secure the support device to the ceiling joists. The panel rests in the gap between the ceiling joist and the top of the housing. However, this device needs to be manually screwed in which is labor intensive, strenuous and time consuming. Furthermore, this device has the ability to possibly damage the building material when it is adjusted into its final position.

Therefore, there exists a need for an apparatus, device, or devices that can be quickly attached to a support structure that can be used in multiple surroundings to facilitate the installation of building materials. Further, a need exists for an apparatus that not only facilitates installation of building materials, but makes that installation safer while also reducing the effort, the labor, the number of people needed to perform the task, and preferably allows the installer to have both hands free to secure the material.

### SUMMARY

The present invention provides an effective and convenient apparatus, devices and/or system for installing building materials either on ceilings or on walls. The apparatus and/or devices allows one individual on his own to install building materials. The invention eliminates the need for one or more persons holding the drywall in place while an initial means of attachment is applied to hold the sheet of drywall in place, thus, allowing an installer to remove the support of their head, or lower their arms. Further, while a first installer is using the devices of the present invention, an additional person(s) can be securing more devices or moving the existing devices in order to be ready to apply the next sheet of drywall. The devices of the present invention provide hands free operations and simplifies the job for a ‘do it yourself’ (D.I.Y.) individual or homeowner. The devices of the present invention eliminate the need to enlists the help of a friend, or friends, or rental of a drywall lift in order to lift the sheet of drywall and hold it in place until the initial means of attachment are in place. The use of the devices of the present invention gives individuals who do not normally do strenuous work the ability to relatively simply apply drywall on their own, the only requirement is being their ability to lift a sheet of drywall without help. The apparatus allows an installer to lower their arms once the building material is temporarily held in place by the apparatus prior to being permanently installed and increases safety.

In accordance with the present invention, the apparatus for installing building materials includes at least one resting surface 50 spaced apart from a fastener. Further in accordance with the present invention, the devices of the invention are first positioned adjacent to where an installer would like to install the building material. The apparatus of the present invention is attached to an existing structure. Once the apparatus of the invention is attached, the installer may then position a section of building materials so that it contacts a resting surface 50. Contacting the resting surface may be further facilitated with the use of a guide surface 70. The building material is then positioned and may be further secured with another device of the apparatuses and/or device of the invention.

### BRIEF DESCRIPTION OF THE FIGURES

FIG. 1 shows a device for supporting building material during installation prior to securing it in its final location, with two resting surfaces and a feature to facilitate mounting the device.

FIG. 2 illustrates a similar device to FIG. 1 for supporting building material during installation prior to securing it in it's final location, with two resting surfaces, one of the resting surfaces being an extension of the surface that is the adjacent mounting surface and a feature to facilitate mounting the device.

FIG. 3 shows a similar device to FIG. 1 with the added feature of a larger target for guiding the material onto the resting surface.

FIG. 4 shows a similar device to FIG. 1 with the added feature of a means of mounting the device onto a clamp.

FIG. 5 illustrates a similar device to FIG. 2 formed in metal, or a composite or molded into a more streamlined part.

FIG. 6 shows a similar device to FIG. 1 formed in metal, or a composite, or molded with the added feature of an anti-rotational feature and a place to attach a means of adding a location feature, to reduce the time to mount the device.

FIG. 7 illustrates a portion of the device of FIG. 6 with the added feature of an adjustable support.

FIG. 8 shows a similar device to FIG. 1 with the added feature of an anti-rotational device.

FIG. 9 shows a device similar to FIG. 6 illustrating a clamp as an integral part with the device of the invention for use when installing building material to metal joists.

FIG. 10 illustrates a device similar to FIG. 6 illustrating a clamp as an integral part with the device of the invention.

FIG. 11 shows a device similar to FIG. 4 shown in combination with a “c”-clamp.

FIG. 12 shows a device similar to FIG. 4 shown in combination with a quick-grip bar clamp.

FIG. 13 illustrates a device similar to FIG. 3 illustrating a bar clamp as an integral part of the device of the present invention.

FIG. 14 shows a device similar to FIG. 4 in combination with a Jorgesen clamp.

FIG. 15 shows a device similar to FIG. 4 in combination with a Pony clamp.

FIG. 16 is a view showing two styles of device in location ready to accept a sheet of building material.

FIG. 17 is a view showing an installer using a rule to mark the location to mount one of the devices.

FIG. 18 is a view showing an installer using a flexible feature for locating the location to mount a clamp style device.

FIG. 19A, B, C, & D shows a method for installing a sheet of building material overhead by one or more installers.

FIG. 20 shows a method of mounting a sheet of building material to a wall.

FIG. 21 shows one style of device having a cam action feature for raising a sheet of building material on a wall.

FIG. 22 shows another style of the device with another style of cam action.

FIG. 23 shows one of the devices of FIG. 7 in use as an extra set of hands during the framing out of duct work.

FIG. 24 shows two of the devices of FIG. 2 in use as an extra set of hands during the installation of a tongue & grooved ceiling.

FIG. 25 shows a similar device to FIG. 5 with two sets of the same guide and resting surfaces, with one set being a distance from the surface that is adjacent to the building material surface.

FIG. 26 shows an adjustable tee-bar for assisting in the application of building materials.

FIG. 27 shows another feature of the device in that spacer pads can be added to the surface adjacent to the building material surface in order to vary the spacing whereby different thickness' of building materials can be installed.

FIG. 28 shows that the device can also be readily adapted for installation of building materials parallel to the ceiling joists.

FIGS. 29A and B illustrate another alternative aspects of the device that include various antirotational features.

### DETAILED DESCRIPTION

The apparatus of the present invention is effective for installing building materials either overhead or on walls. As used herein the term “building materials” includes sheet drywall; paneling, sheet or plank; insulation board, plywood, siding, tongue and grooved planks, framing out of duct work, any form of wood sheet, wood composite sheet, rigid plastic sheet, plastic laminated sheet, expanded plastic (foam sheets), and, any other form of sheet material or planking.

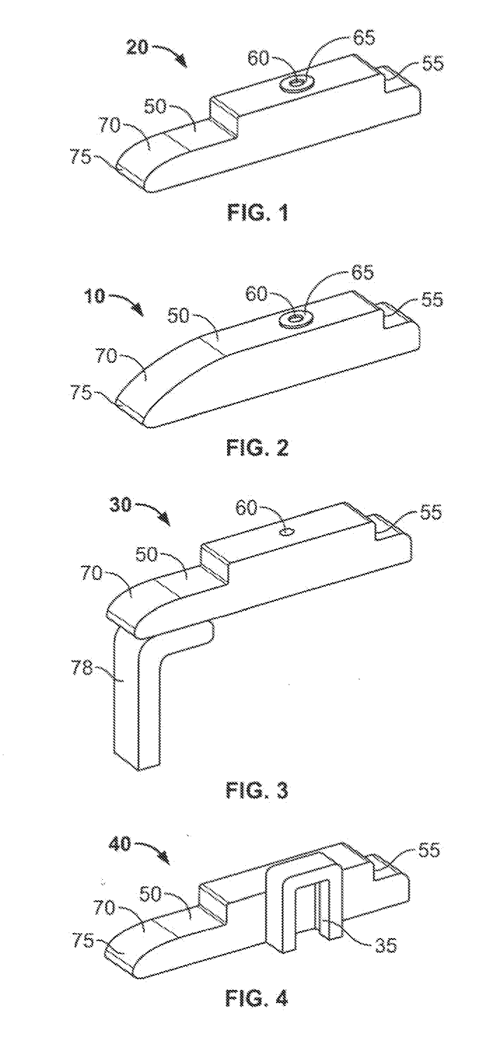

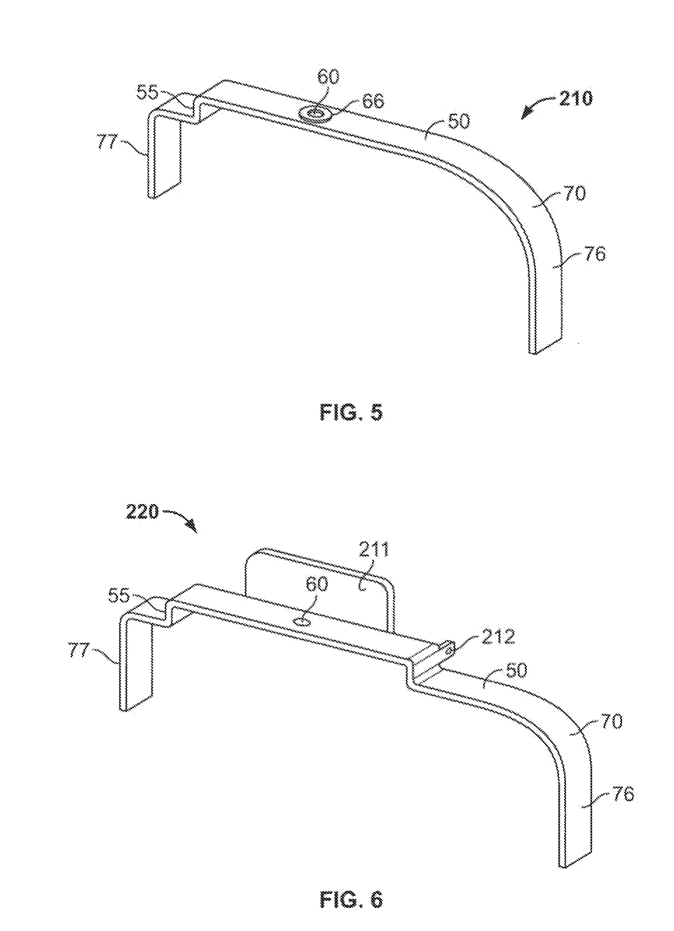

The apparatus of the present invention may be made of a variety of materials including wood, metal, plastic and combinations thereof. The devices shown in FIGS. 1 through 4 and 8 would generally and more appropriately be made of wood; molded in plastic; molded in a filled plastic; a powdered metal or cast in metal and the devices shown in FIGS. 5 through 7 would generally and more appropriately be made of metal; filled plastic; plastic or powdered metal. If the device as shown in 5 through 7 was made in plastic then a person skilled in the art would probably include a support web for both extended target surfaces 76 and 77 running at an angle from a point on the back of the surfaces to the underside of surface 50 and/or the underside of adjacent mounting surface.

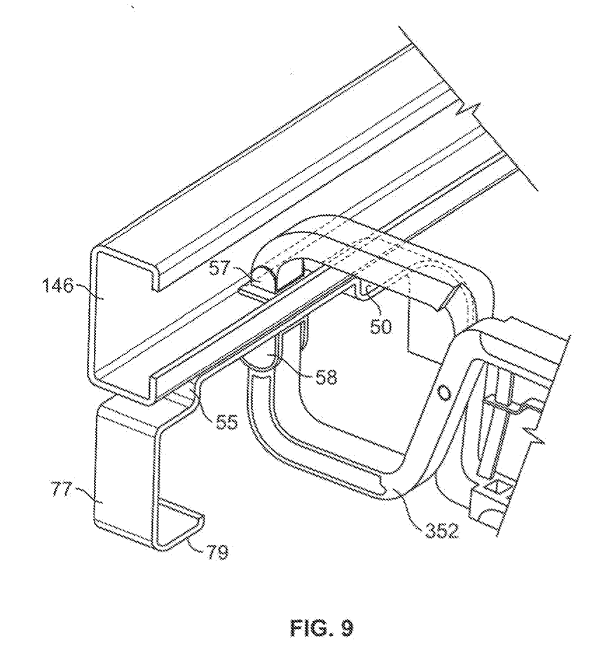

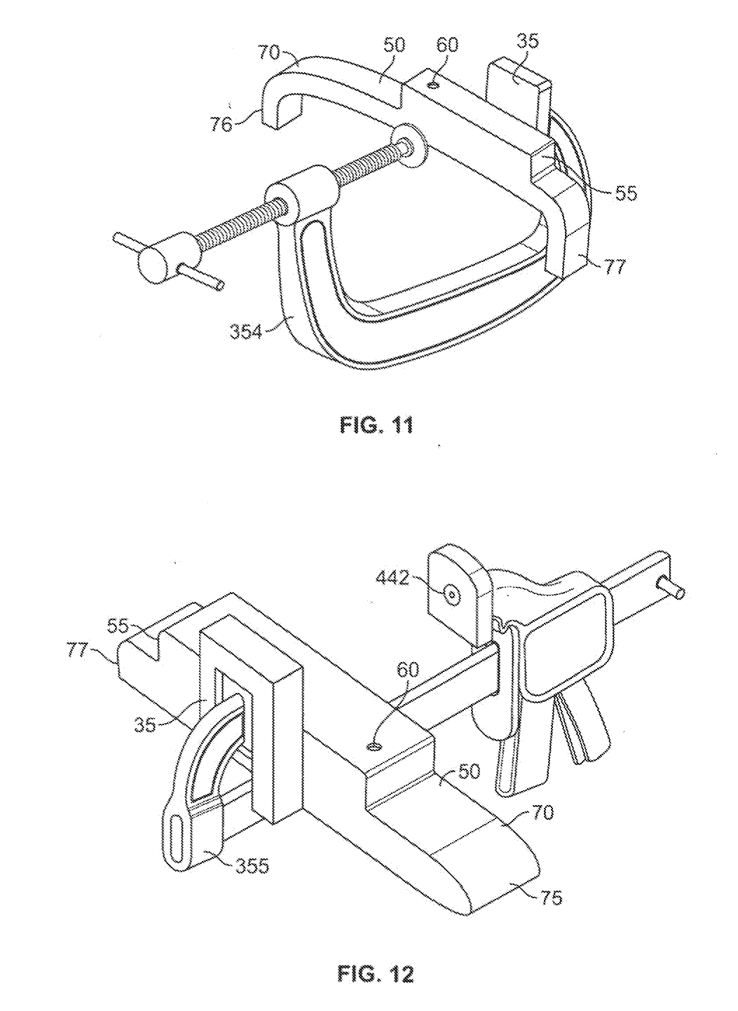

Several important aspects of the apparatus of the present invention are shown in FIGS. 1-3. As shown in FIG. 1, a device of the apparatus of the present invention 20 includes a resting surface 50 spaced apart from a fastener. As used herein, “fastener” may include at least one fastener opening 60 used in combination with a fastener component as described below; a device having a means of attaching a clamp to the device as shown in FIGS. 11, 12 and 14; a clamp as an integral part of the device as shown in FIGS. 9, 10, 13 and 15; and various combinations thereof.

In another aspect, the apparatus of the invention may further include a second resting surface 55, as shown in FIGS. 1 through 6 or a shortened resting surface 75 as shown in FIGS. 1, 2 and 4. In its basic form, the device of the invention only requires one resting surface, however, a second resting surface provides a user with added versatility at low cost.

Either one or both of resting surface 50 and second resting surface 55 may include a guide surface 70, a second continuous guide surface 76, an elongated continuous guide surface 77, a detachable guide surface 78, and combinations thereof. The guide surface 70, second continuous guide surface 76, and continuous elongated guide surface 77 may be continuous with the resting surface 50 and/or the second resting surface 55. In one aspect of the invention, the second resting surface 55 includes a continuous elongated guide surface 77, associated with it for use when putting sheeting on walls or cathedral ceilings.

In alternative aspects of the present invention, the guide surface 70 may generally extend downward from the plane of the resting surface 50. The downward extension of the resting guide surface 70 may be gradual, as shown in FIG. 1 or 2. Alternatively, a shown in FIGS. 5 and 6, and continuous elongated guide surface 77 may be at a more extreme angle. As shown in FIG. 3, the apparatus of the invention may also include a detachable elongated guide surface 78 which acts as a bigger target area for the installer(s) to find with the leading edge of a sheet of building material and to further facilitate the guiding of building materials to the resting surface 50.

In another aspect of the present invention, the apparatus for installing building materials may include at least one fastener opening 60. The fastener opening 60 may be an opening that passes completely through the apparatus 10. The fastener opening 60 has a diameter sufficient to allow any type of fastener component to be used with the apparatus. As used herein, “fastener component” means any type of screw, nail, rivet, or bolt that can be used to secure the apparatus or device generally designated 10, 20 or 30 to an exiting structure or support material. In this aspect of the invention, the fastener may pass through the fastener opening 60 and directly into a ceiling joist or wall stud, or first through a piece of building material before then passing into a ceiling joist or wall stud. The fastener component may allow the apparatus 10 to be circularly rotatable around its attachment point. The fastener opening 60 may also include a metal sleeve(s) or bushing(s) 65 in order to prolong the life of the device. The sleeve or the apparatus itself can include a holding feature effective for retaining a fastener component in place. For example, the sleeve can be magnetized to hold the fastener component in place which facilitates not having to manually hold the fastener component in place. Once the device of the invention is removed, a drywall screw is place into the hole left by the fastener, which removes any evidence that a fastener component passed through the building material. In an important aspect, the fastener component used is a drywall screw.

As indicated herein, the fastener opening 60 used in combination with a fastener component. In this aspect, the fastener component rotates independently of the apparatus. This independent rotation facilitates positioning and attachment of the apparatus to a support structure.

As shown in the Figures, the apparatus includes a fastener opening 60. In this aspect, surfaces extend away from the fastener opening 60 in both directions. In an important aspect, a first surface extends away from the fastener opening 60 at least about one inch or more in each direction. Generally, the fastener opening 60 is spaced away from the ends of the apparatus and is generally located in a middle section of the apparatus. This positioning of the fastener opening 60 allows the materials being installed to contact against each other with no gap between materials. Further, this positioning of the faster opening 60 allows the materials being installed to be installed in a more parallel position to the structure to which the building materials are being attached.

Another aspect of the present invention is shown in FIG. 4, where the apparatus includes a clamp adaptor 35 and does not include a fastener opening. In another aspect, as shown in FIG. 11, the apparatus may include both a fastener opening 60 and clamp adaptor 35. As used herein, the term “clamp” includes all clamp designs that can or could be modified to fit onto or be incorporated as an integral part of the design of the present invention. Examples of clamps include “C”-clamps, vice-grip, bar-clamps, and pony-clamps. The use of a clamp in combination with an apparatus of the invention that includes a clamp adaptor is shown in FIGS. 11, 12 and 14.

As shown in FIG. 5, the device generally designated 210 of the present invention may also include a continuous elongated guide surface 77 and a second continuous guide surface 76 that are perpendicular to the plane of the building materials being installed. These guide surfaces 76 and 77 aid the installer in contacting building materials with the device. In another aspect of the invention as shown in FIG. 5, the device may include a slightly raised surface 66 around the fastener opening 60. The raised surface 66 reduces the possibility of marking the building material during rotation of the device.

A more streamlined version of the device 220 is shown in FIG. 6. In this aspect of the invention, the device 220 includes a resting surface 50 continuous with a guide surface 70 and a second continuous guide surface 76, and a second resting surface 55 continuous with an elongated guide surface 77.

Another aspect of the invention is shown in FIG. 6 where the apparatus 220 includes an anti-rotational feature 211 which may allow the device to be clamped to a support structure. The anti-rotational feature 211 also serves as an easy locator when addressing the device to the support structure, and also facilitates locating the mounting of the device by placing the fastener opening 60 roughly in the center of a standard joist. Further, the apparatus may also include an attachment opening 212 for attaching a positioning feature, such a chord, a chain or a spring return device. Hence, the measurements of the device are effective for properly locating the device to facilitate installation of building material.

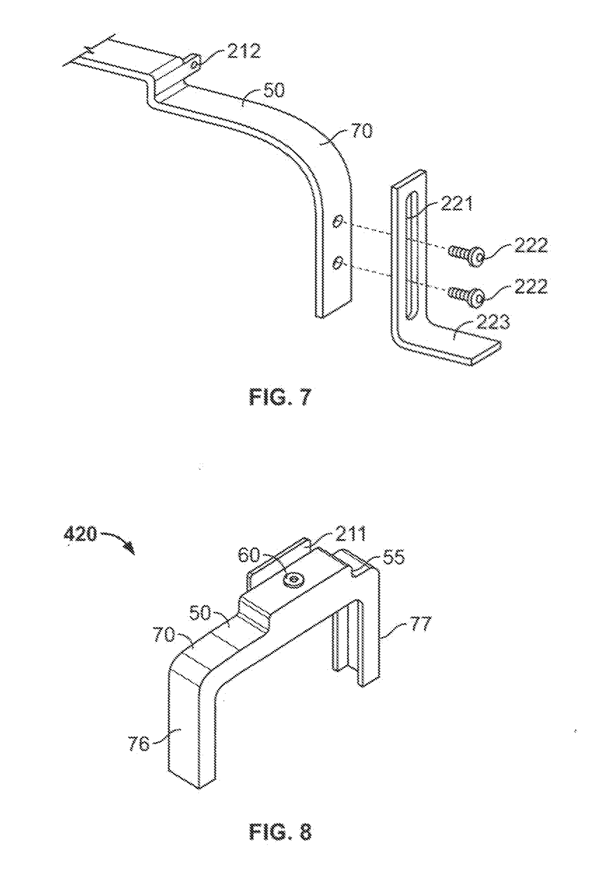

Referring to FIG. 7, there is shown a means of adding another support surface 223. In this instance, the support surface 223 is shown as being attached via screws 222 and a slot 221 which allows adjustment of the location of the support surface 223. It is understood that a person skilled in the art can easily design other means of adjustment for this additional surface and these means are hereby included. This feature can be used as an extra pair of hands in supporting a framework that requires holding in place temporarily prior to permanent attachment, hence, allowing the carpenter to operate hands free.

Referring to FIG. 8, this figure shows a preferred one piece device generally designated 420. This device can be made from wood, molded from plastic, filled plastic, powdered metal, cast in metal, or a combination of these materials. The device 420 includes a continuous elongated guide surface 77, a second continuous guide surface 76, an anti-rotational feature 211 and a fastener opening 60. If the device is made in plastic then it optionally may include an inserted bushing in the fastener opening 60. In devices made of powdered metal or metal this feature would not be required.

Various aspects of the invention that include the use of the device in combination with a clamp are shown in FIGS. 9 through 15. Many styles of clamps are manufactured by various manufactures including Stanley, Craftsman, Wolfclamp, Pony clamp, Jorgenson, Bessey, Vice Grip, American Tool, plus numerous others which are hereby included in this invention. In an important aspect of the invention, the clamps used include bar clamps, quick grips, power press, cabinet clamp, euro claw, deep reach bar clamps, k-body clamps, vice grips, hand clamp, pony clamps, Jorgenson clamps, c-clamps, ratchet clamps, and various other names and styles of these clamps with or without manufactures names that can readily be adapted or designed to accommodate, or have, the features of any or all of the above devices; and, are hereby included in this invention,

As shown in FIG. 9, the device may be used in combination a hand-clamp 352 for use during the installation of sheet building material to metal studs.

Both jaws have a pivoting feature 57 and 58 that permit the clamp surfaces to be parallel to each other when closed. As further shown in FIG. 9 is a folded surface 79 continuous with the elongated continuous guide surface 77. The folded surface 79 eliminates a sharp edge when using this style of device to install building material against a wall.

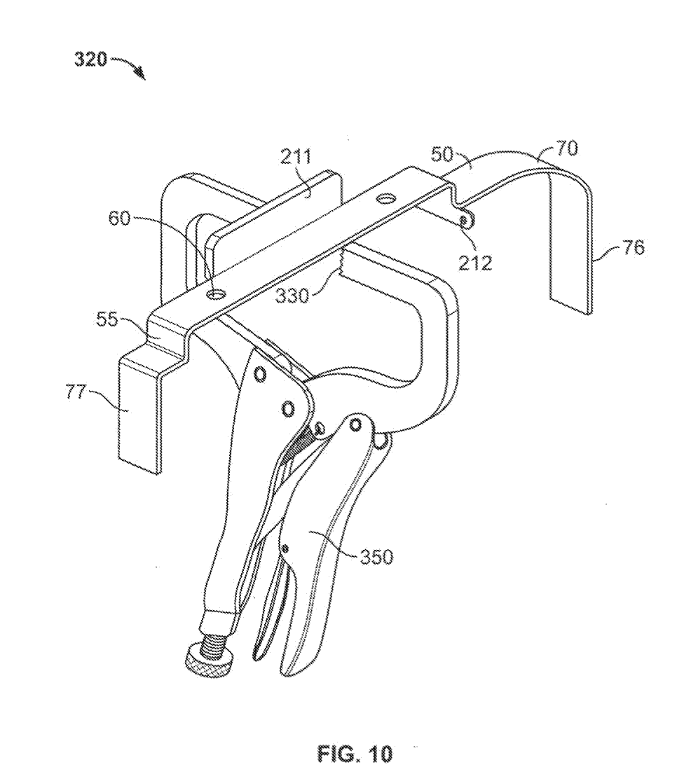

The device of the present invention 320 in combination with a pair of vice grips 350 is shown in FIG. 10. The vice grips 350 may include serrated teeth 330 useful for biting into wooden joists to more firmly secure attachment of the vice grips 350 to a joist. The serrated teeth 330 may include a single point, multiple teeth, or any other design that would dig into a joist and be effective for securing the clamp to the joist.

The device of the present invention in combination with a “C”-clamp is shown in FIG. 11. FIG. 11 shows a device of FIG. 8 where the anti-rotational feature 211 is replaced with a clamp adaptor 35. The clamp adaptor 35 provides a surface where a “C”-clamp 354 can contact the device to secure it in place.

Referring to FIG. 12, this Figure shows a device of FIG. 4 in combination with a bar-clamp 355. In this aspect of the invention, the device includes a clamp adaptor 35 whereby the device can be slid onto one of the jaws of an existing style of bar-clamp 355. The opposing jaw of the bar-clamp may include an antislip feature 442. The antislip feature 442 may include single or multiple protrusions effective for securing the clamp to a wooden joist to prevent sliding of the clamp.

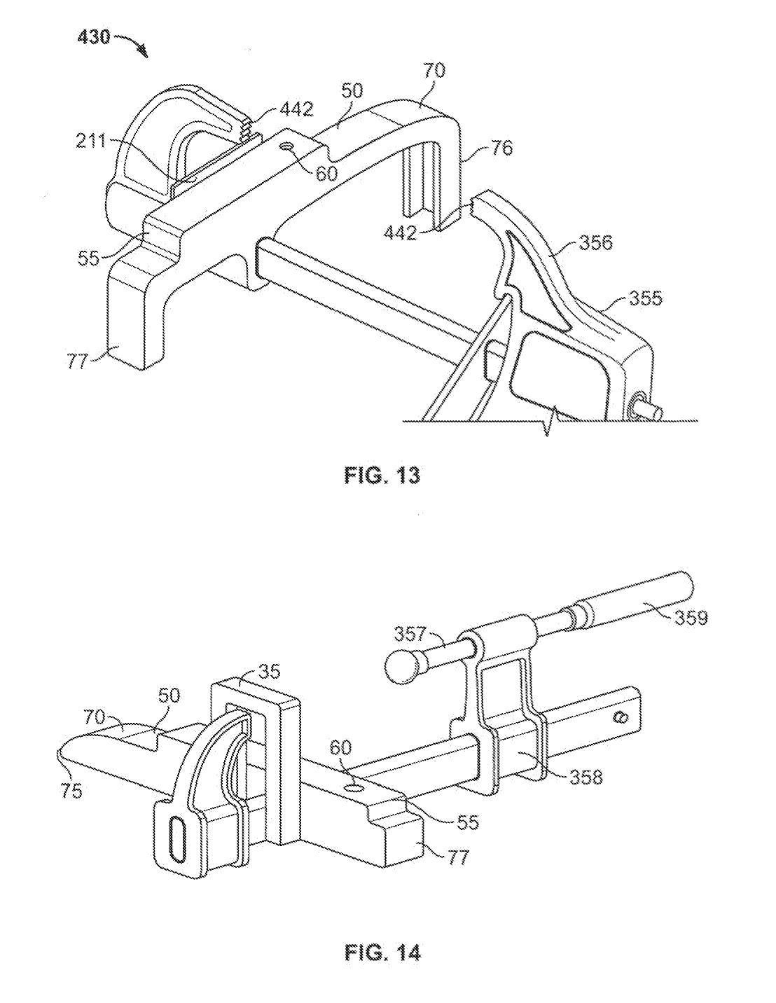

Another aspect of the device of the present invention is shown in FIG. 13. The device of the 430 may be integrally combined with a bar-clamp 355 such that the device 430 and modified bar-clamp 355 are one piece. As shown in FIG. 13, both jaws are shown as having an antislip feature 442 which is effective for bitting into a joist and preventing slippage. With a bar-clamp as shown in this FIG. 13 and FIG. 12 one of the jaws is stationary and generally part of the bar; while, the other moveable jaw 356 is moveable by means of a squeezing action that is perpendicular to the bar, an example of which is a quick-grip type clamp. Other styles of bar-clamps actuate the moveable jaw by a squeezing action parallel with the bar, an example of which is a EZ-hang type clamp and by means of a thread clamp such as a c-clamp.

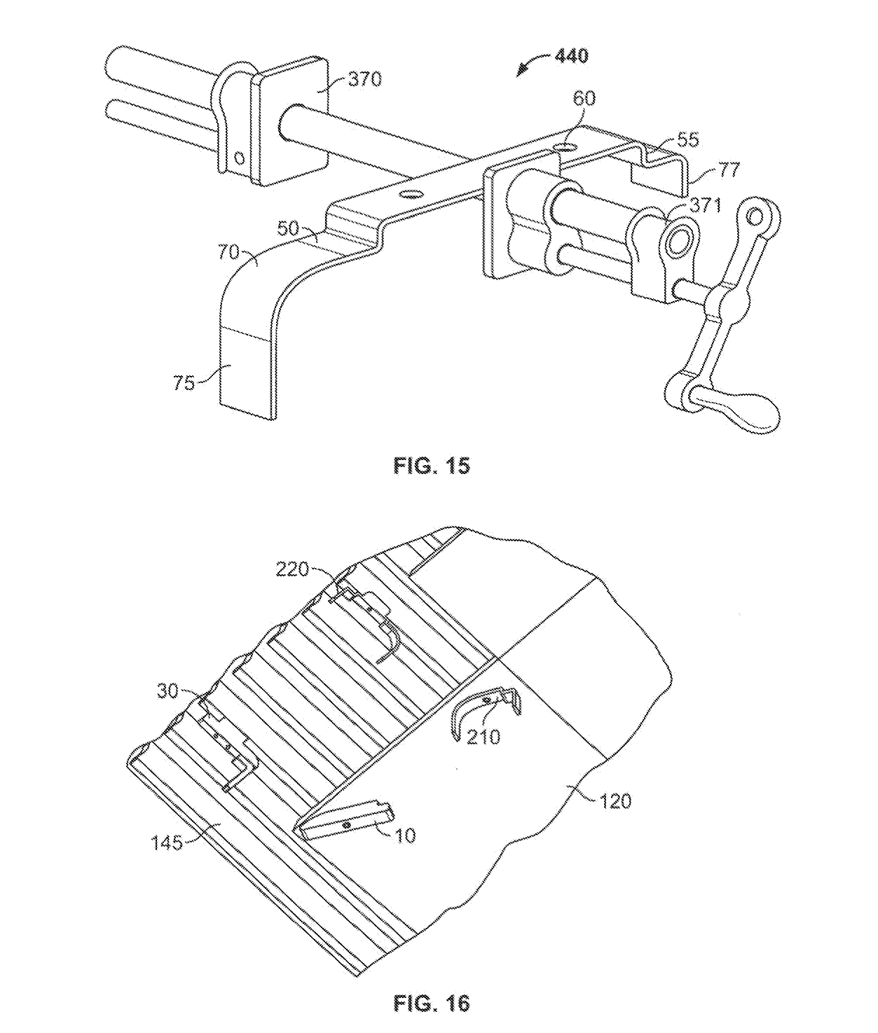

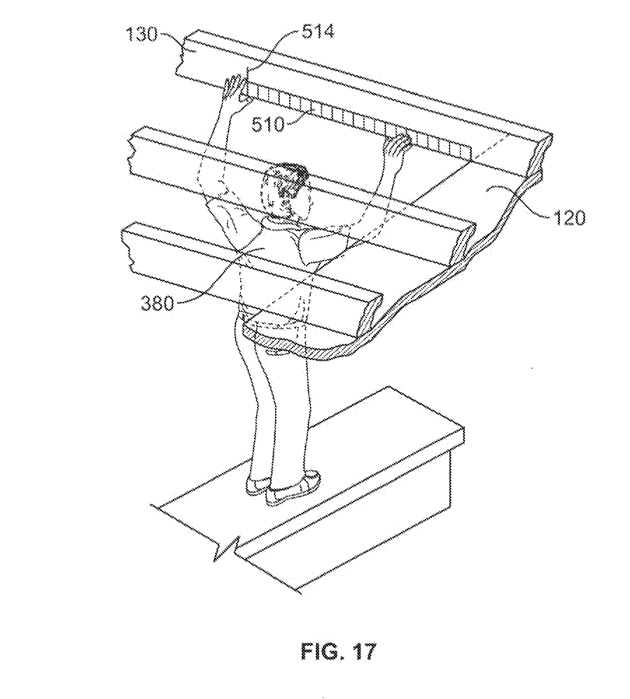

Referring to FIG. 14, this figure shows another style of bar-clamp know as a Jorgensen clamp in combination with a device of FIG. 4. The moveable end 358 is first moved to a snug position then tightened up using the jaw mounted on a thread 357 by turning the handle 359.

Another aspect of the invention is shown in FIG. 15. In this figure an apparatus generally designated 440 is shown in combination with a clamp known as a “pony clamp”. The fixed end 371 of the clamp is screwed on to a piece of black pipe with the adjustable jaw 370 slid on to the pipe. The rough adjustment is done with the adjustable jaw 370 and the final tightening by cranking the handle on the fixed end. It is to be understood that any of the devices shown could be used in combination with any clamp either attached or as an integral part of the device of the invention.

Various aspect of the use of devices of the present invention are shown in FIGS. 16-25 and positioning of the device of the present invention is shown in FIGS. 16-18. As can be seen in the Figures, each apparatus of the invention is positioned to facilitate installation of the first or next piece of building material. Referring to FIG. 16, in this figure two pair of styles of devices are shown in ceiling location ready to have a sheet of building material put in place. One device of each set is mounted on the ceiling joists 130 and the other mounted through the drywall 120 and into the ceiling joists 130. One style comprises of a pair of devices as reflected by 10 and 30; and the other pair's style are reflected by 210 and 220.

Referring to FIG. 17, this figure shows an installer 380 marking the location 514 on the ceiling joist 130 using a rule that is forty-eight an a half inched long. This distance is measured from the edge of a wall or a previously installed sheet. The half inch play is more than enough to place the sheet flush with the ceiling joist and leave little distance to move the sheet in order to put it in place for attachment. most sheets of material are 4′×8′ long or 4′×12′ long; but, the metric equivalent of sheet sizes would be allowed for by a rule half an inch longer than the width of the metric standard for building material sheeting.

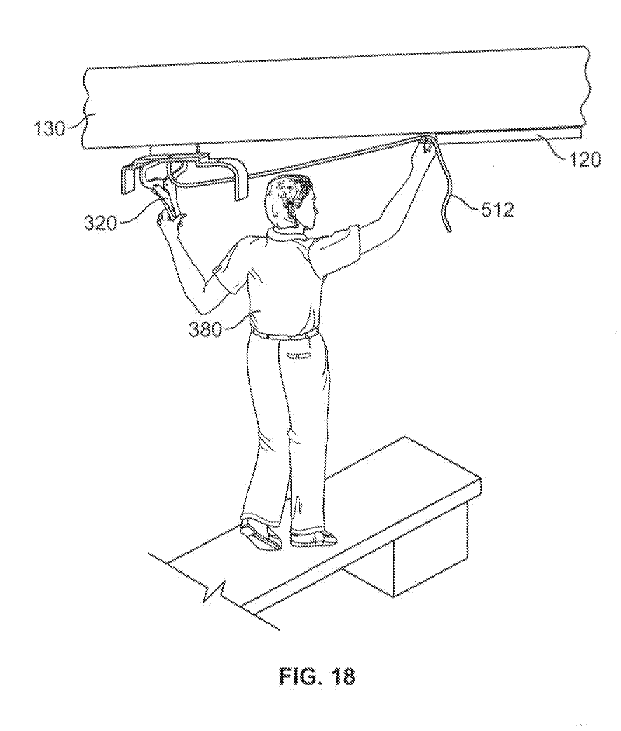

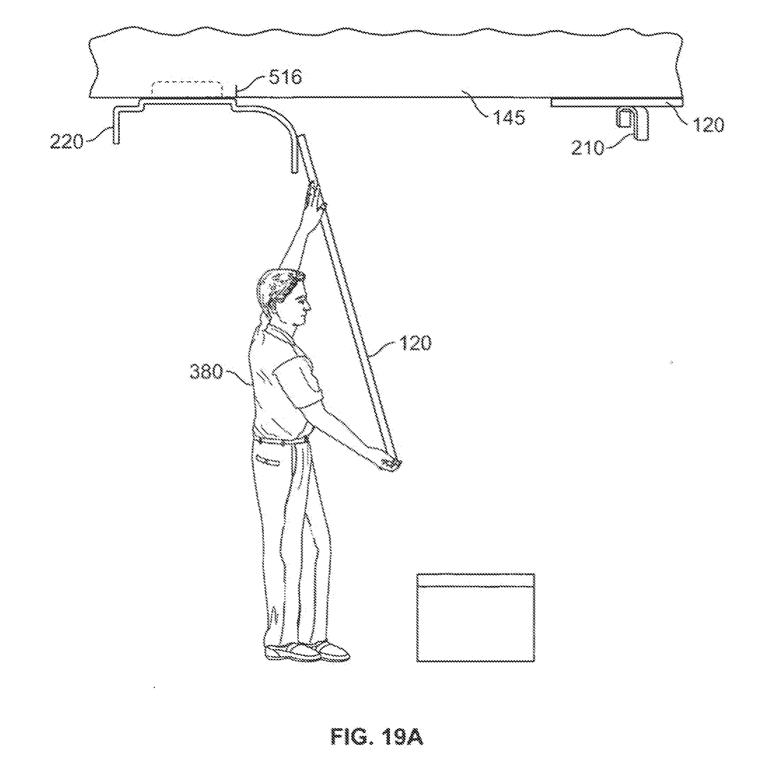

Another means of locating the device 320 to ceiling joist 130 is shown in FIG. 18. As shown, a flexible length of material 512 by holding a the predetermined mark on the flexible material against either the wall or previously attached sheet stretching it to its limit and attaching in this figure the clamp 320. Positioning of building material may be accomplished using a positioning device such as a chord 512 and/or measuring device 510, and may also include a chain or a spring return device (not shown).

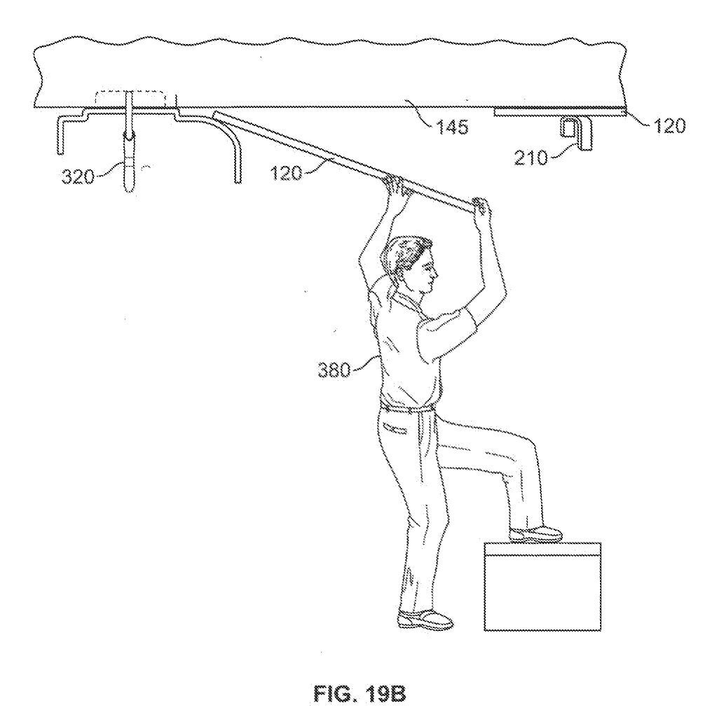

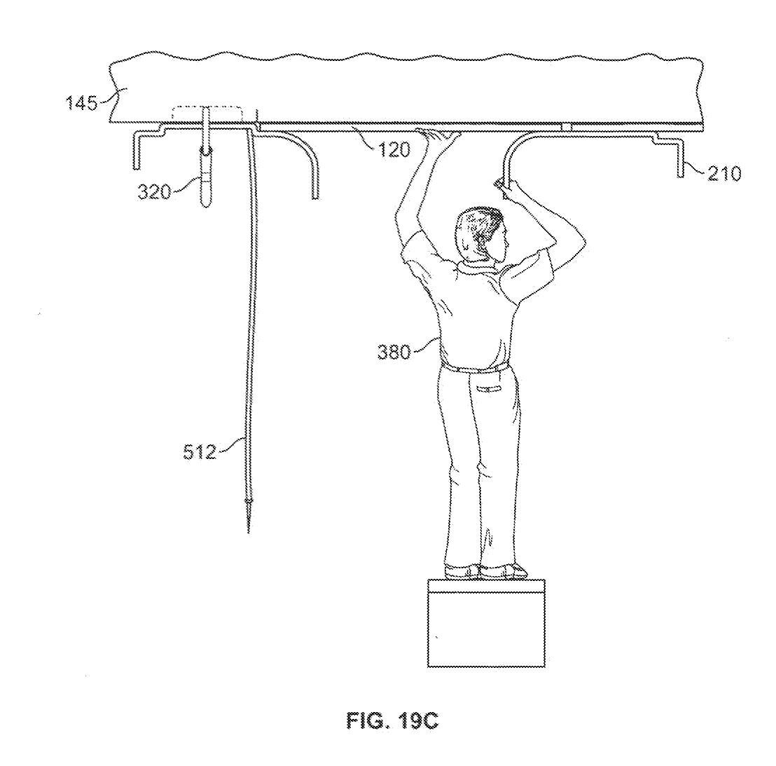

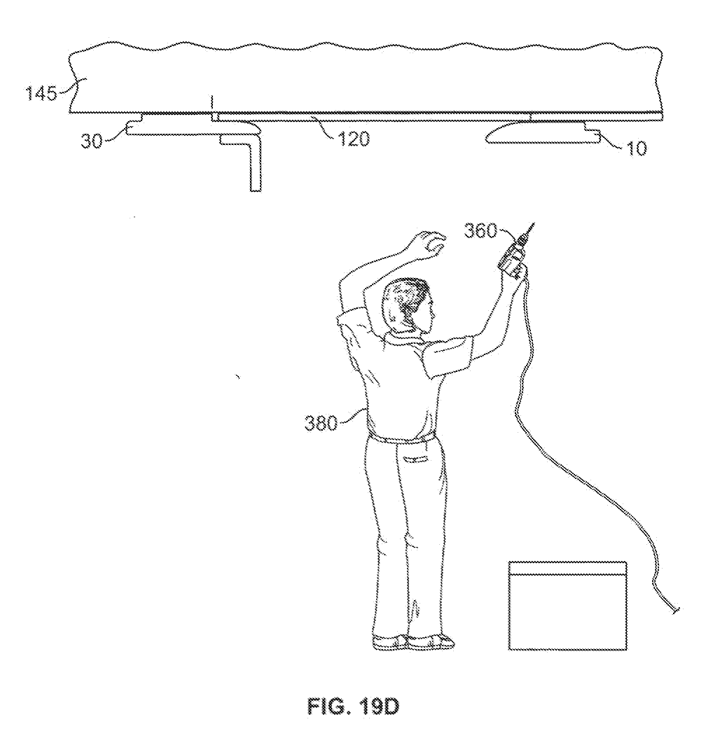

Installation of the building material 120 is shown in FIGS. 19A-D. Referring to FIGS. 19 a, b, c & d, these views show a preferred method of installing building material sheets on a ceiling. In this illustration the installer 380 is putting up drywall. After marking the location and installing the devices the drywall 120 is lifted in the near vertical to vertical position and the top edge is engaged with the guide surface of the devices. Building material is then lifted up till it hits the ceiling joists, at which time maintaining a upwards pressure locate the leading edge of the drywall into the pockets created by the devices and ceiling joists as shown in FIG. 19b; and, rotate as shown in FIG. 19b into the horizontal position as shown in FIG. 19c. Then the device 210 is rotated into position to support the sheet of drywall 120. Then the installer is hands free to use his screw gun 360 to permanently mount the sheet of drywall as shown in FIG. 19d. When using these devices on an eight foot long sheet it is recommended that two sets of the devices be used; and, on a twelve foot long sheet three sets of these devices be used.

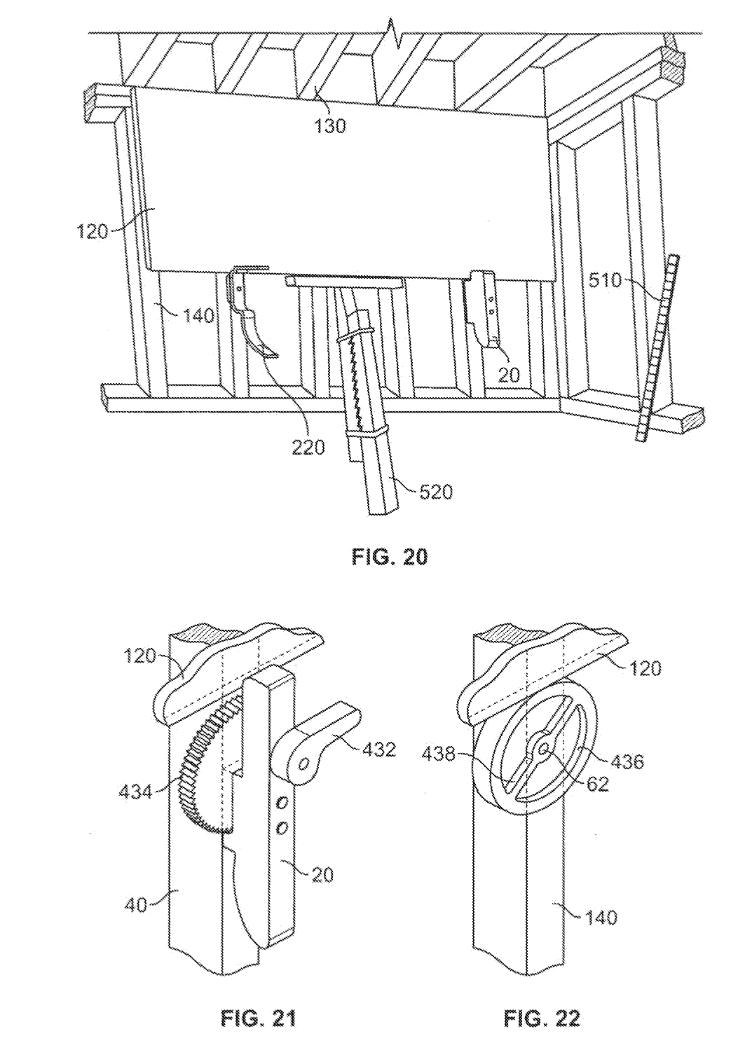

A method for installing building material on a wall is illustrated in FIG. 20. In accordance with the invention, an installer first marks the locations for mounting the device of the present invention using a measuring device 510. One of the marks made by the installer is just over four feet and the other at four feet and a half inches down from the ceiling or other sheet. The devices of the inventions, shown as 20 and 220 are secured into position. Other devices of the invention may be used, for example, device 40 in combination with a clamp, device 420, device 320 as shown in FIG. 10, and device 430 in FIG. 13. The drywall 120 is placed into pockets created by the device of the invention and studs, and rotated into a vertical position. Then using a tee bar 520, the drywall 120 is manually raised so that the top edge of the drywall is flush with the ceiling. In a typical installation, the ceiling panels may already be in place, whereas, FIG. 20 shows an open ceiling.

An alternative method of raising building material is shown in FIGS. 21 and 22. Instead of using a tee-bar or manually raising the material, the material my be raised using a cam feature as shown in FIG. 21 by rotating handle 432. With rotation, the eccentric cam 434 raises the drywall 120.

Referring to FIG. 22, this figure shows another alternative method of raising a sheet of drywall 120 via another design of cam 436 which rotates around the mounting feature 62; and, by the means of twisting the cam using web 438 the drywall sheet is raised.

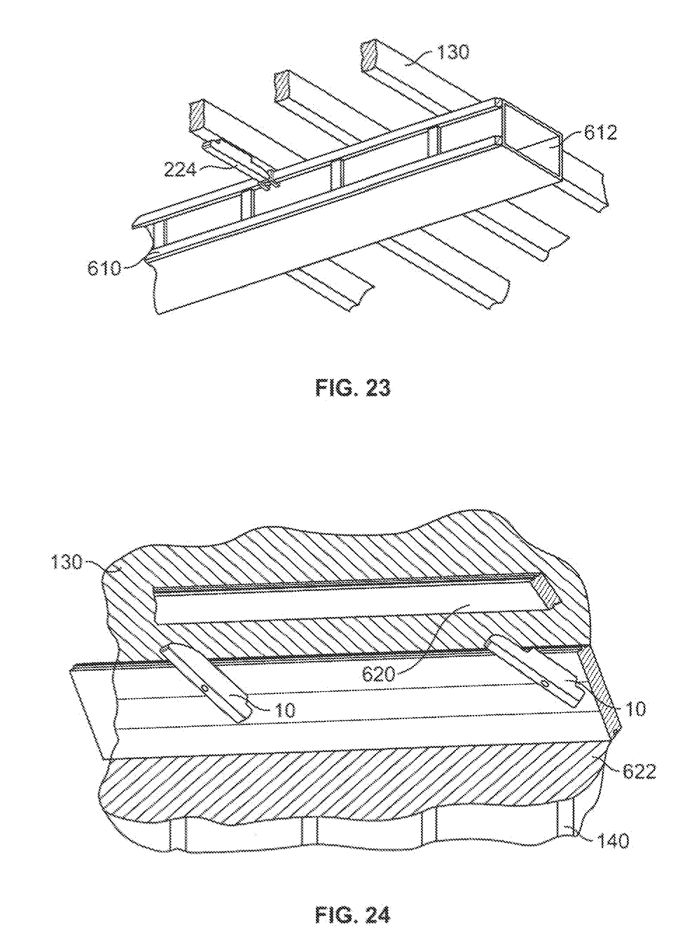

An alternative use of the device of the present invention is shown in FIG. 23. In this figure, a device with an adjustable additional surface 224, as illustrated by the feature in FIG. 7, is shown attached to a ceiling joist 130 and acting as an extra pair of hands to hold the frame work 610 while framing out ductwork 612, thus leaving the installers hands free to adjust and secure the framework.

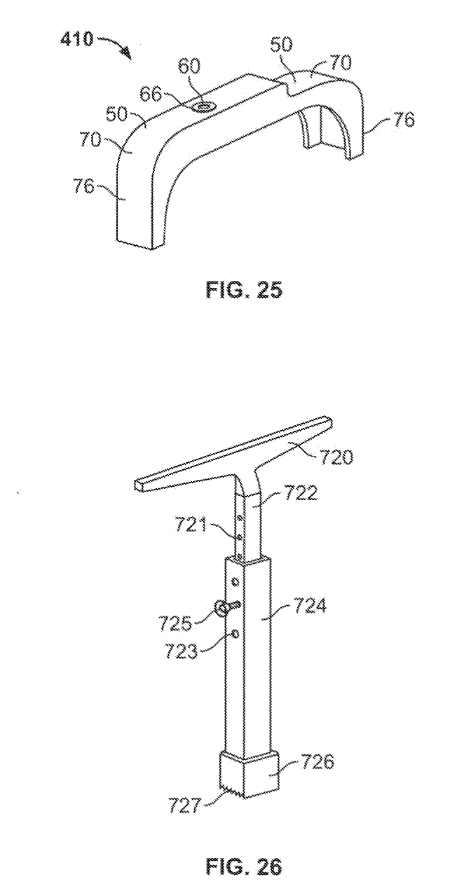

Another use of the device of the present invention is shown in FIG. 24. In this figure a pair of the devices 10 are used to support and place long tongue and grooved planks 620 into a location against ceiling joists 130, thus, freeing up the installer to secure the planks. It is understood that anybody skilled in the art of construction can readily see using these devices to mount numerous types of building materials on walls or ceilings. Although the devices designated 10 are shown in the figure it is understood that it could just as easily be the device of FIG. 5 or FIG. 25 and are thereby included in this invention.

Referring to FIG. 25, this figure shows a preferred one piece device generally designated 410. This device can be made from wood; molded from plastic; filled plastic; powdered metal or cast in metal. reflected are the three guide surfaces 70, 76 and 77, on both sides of the fastener opening 60. As shown in this figure one set of the surfaces is spaced at distance from the adjacent surface that contacts the structure surface to which the device is mounted. If the device is made in plastic then it possibly may include an inserted bushing. In powdered metal or metal this feature would not be required. Also shown is a raised area 66 which is not essential to the device provides a added advantage of reducing possible marking of the building material surface when being rotated into position.

Referring to FIG. 26, this figure shows an adjustable tee support comprising of a head piece 720 two tubular vertical support piece 722 and 724 which slide one inside the other. Holes 721 and 723 that allow a pin 725 to be placed through both tubes in order to facilitate different heights of use; and, although not necessary for the function of the tee-bar a boot 726 with a roughened base 727 to stop marking the floor. It is understood that anybody skilled in the art could modify the design with a removable head to facilitate storage or transportation, add a coating to the head or make it out of a material that will reduce or eliminate marking the building material, or make the head with limited rocking ability.

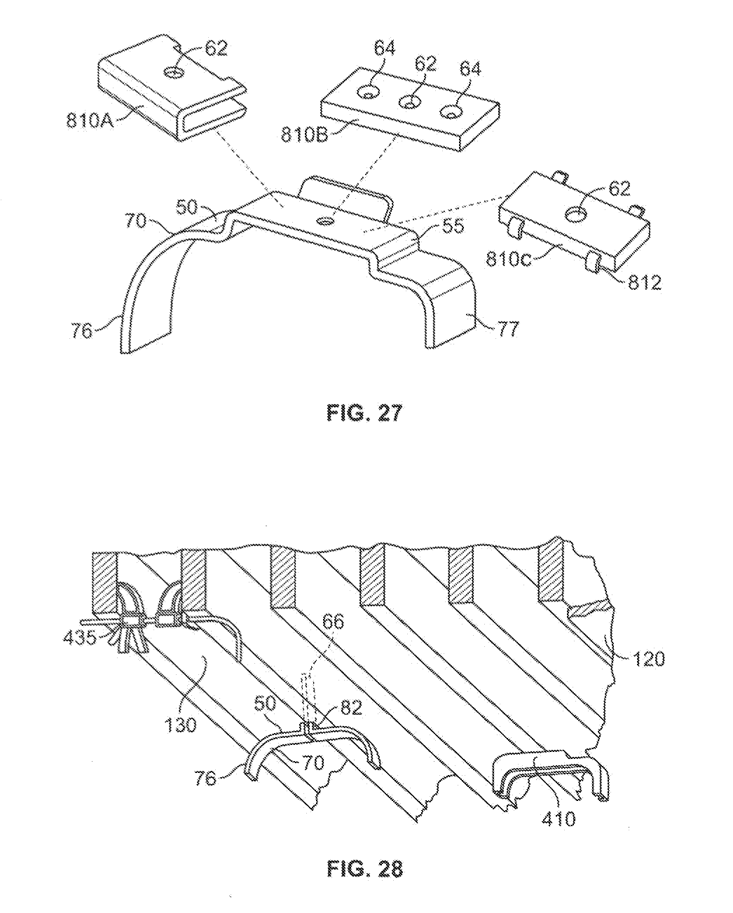

Referring to FIG. 27, this figure shows an additional feature of the present invention for adding space between the apparatus of the present invention and the building material being installed. This feature provides the installer with the ability to install a verity of different thicknesses of building material with the same basic device. In this figure three designs of height block 810a, 810b and 810c are shown. The height block 810a shows an extrusion with a clearance hole 62 for the means of mounting the device to the structure. The height block 810b is a block with mounting holes 64 and clearance hole 62. The height block 810c shows a design with clip on feet 812 and a clearance hole 62.

Referring to FIG. 28, this figure shows the device of FIG. 26 having two sets of the same guides 76 and 70. Also two surfaces 50 with a center mounting post and means of attachment 66 mounted at right angles to the ceiling joist 130. An additional stop 82 is added to give the required gap for the building material to be inserted. In accordance with the invention, building material is raised vertically to near vertical to contact guide surface 76. The building material is lifted and rotated into position and device 410 is rotated to support the building material. Further shown is an alternative bar clamp design in which the jaws open instead of close. It is understood that any competent designer can add this feature to many of the designs of clamp and are hereby included in this invention.

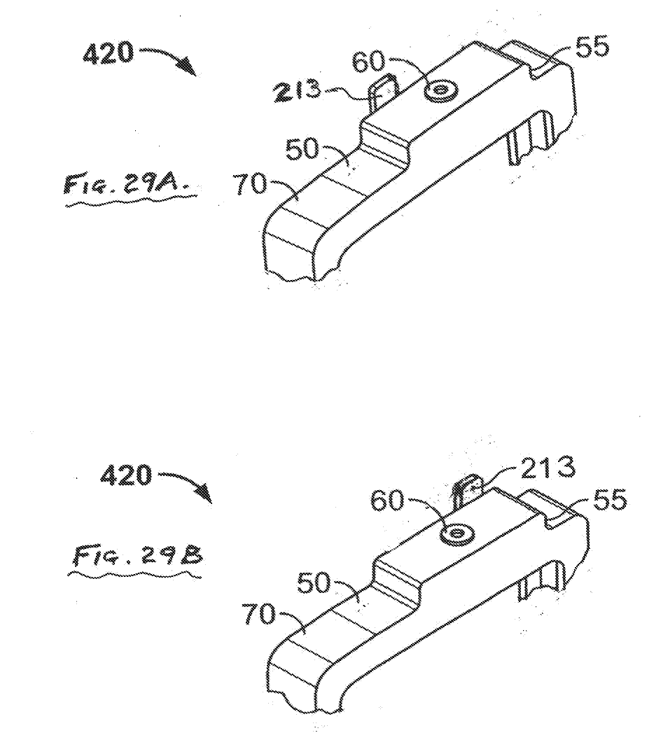

In another aspect shown in FIGS. 29A and B, the antirotational device 213 may extend to either side of the fastener opening 60 or be located on one or the other side of the fastener opening 60.

Numerous modifications and variations in practice of the invention are expected to occur to those skilled in the art upon consideration of the foregoing detailed description of the invention. Consequently, such modifications and variations are intended to be included within the scope of the following claims.

What is claimed is:

1. An apparatus for installing building materials comprising:
a first surface comprising a fastener, the first surface extending away from the fastener in both directions, the first surface attached to a resting surface, wherein the resting surface is not in the same plane as the first surface;
at least one guide surface continuous with the resting surface and extending away from a plane of the resting surface; and
at least one target surface continuous with the guide surface and extending away from a plane of the resting surface.

2. The apparatus of claim 1 wherein the fastener is spaced apart from the resting surface.

3. The apparatus of claim 2 wherein the fastener is a fastener opening in the first surface in combination with a fastening component.

4. The apparatus of claim 2 wherein the fastener is a clamp adaptor and clamp.

5. The apparatus of claim 2 wherein the fastener is a clamp.

6. The apparatus of claim 5 wherein the clamp is selected from the group consisting of c-clamps, pony clamps, Jorgensen clamps, EZ hold clamps, bar clamps, power press clamps, cabinet clamps, euro claw clamps, deep reach bar clamps, k-body clamps, hand clamps, ratchet clamps, quick grip bar clamps, vice grip clamps, and combinations thereof.

7. The apparatus of claim 6 wherein the clamp includes at least one pivoting feature.

8. The apparatus of claim 6 wherein the clamp has at least one means for penetrating into a support structure to enhance securing the apparatus in place.

9. The apparatus of claim 8 wherein the clamp is an integral part of the apparatus.

10. The apparatus of claim 1 wherein the apparatus for installing building material further comprises an anti-rotational feature.

11. The apparatus of claim 1 wherein the apparatus further comprises a cam feature.

12. The apparatus of claim 1 further comprising a positioning feature.

13. The apparatus of claim 2 further comprising at least one material thickness spacer.

14. The apparatus of claim 2 further comprising at least one adjustable support surface.

15. The apparatus of claim 1 wherein the apparatus for installing building material is made from a material selected from the group consisting of wood, metal, plastic, and combinations thereof.

16. The apparatus of claim 1 further comprising an adjustable tee support.

17. The apparatus of claim 1 further comprising a holding feature effective for retaining a fastener component in place.

18. The apparatus of claim 17 wherein the holding feature is a magnetized sleeve.

19. The apparatus of claim 10 wherein the anti-rotational feature extends to either side of the fastener opening or is located on one or the other side of fastener opening.

20. The apparatus of claim 3 wherein the fastening component is circularly rotatable around its point of attachment in a manner effective for facilitating positioning and attachment of building materials.
